(19) United States
(12) Patent Application Publication
(10) Pub. No.: US 2023/0128754 A1
(43) Pub. Date: Apr. 27, 2023

(54) TERMINAL COMPONENT, SECONDARY BATTERY, AND METHOD FOR PRODUCING TERMINAL COMPONENT

(71) Applicants: Prime Planet Energy & Solutions, Inc., Tokyo (JP); HITACHI METALS, LTD., Tokyo (JP); AOYAMA SEISAKUSHO IBARAKI PLANT CO., LTD., Ibaraki-ken (JP)

(72) Inventors: Koshiro YONEDA, Ichinomiya-shi (JP); Takayuki FURUJO, Suita-shi (JP); Naonori ISHII, Hitachi Ota-shi (JP)

(21) Appl. No.: 17/969,687

(22) Filed: Oct. 20, 2022

(30) Foreign Application Priority Data
Oct. 22, 2021 (JP) 2021-172988

(51) Int. Cl. H01M 50/562; H01M 10/0525; H01M 50/564

(52) U.S. Cl. CPC H01M 50/562; H01M 10/0525; H01M 50/564

(57) ABSTRACT

A terminal component for a secondary battery disclosed herein has a platelike head portion with a bottom surface and an upper surface in an opposite side to the bottom surface and a shaft portion extending from the bottom surface. The terminal component includes a first metal, and a second metal joined to the first metal and having a higher ductility than that of the first metal. The bottom surface of the head portion is formed of the first metal. The upper surface of the head portion is formed of the second metal. A circumferentially continuous chamfered portion is provided in an outer end portion of the bottom surface of the head portion. A boundary between the first metal and the second metal is formed in the chamfered portion.

### CROSS REFERENCE OF RELATED APPLICATION

The present application claims priority from Japanese Pat. Application No. 2021-172988 filed on Oct. 22, 2021, which is incorporated by reference herein in its entirety.

### BACKGROUND

The present disclosure relates to a terminal component, a secondary battery, and a method for producing a terminal component.

Japanese Pat. No. 6581440 discloses a battery terminal including a shaft portion and a flange portion that radially spreads from the shaft portion in a radial direction. The battery terminal is formed of a cladding material in which a first metal layer and a second metal layer are joined to each other. In the shaft portion, the first metal layer has a portion protruding from the flange portion toward the shaft portion at least in a central portion of the shaft portion. The protruding portion protrudes in a convex shape by a larger length than a length of the flange portion in an axial direction. The battery terminal disclosed in Japanese Pat. No. 6581440 has the protruding portion, and thus, an area of an interface of the first metal layer and the second metal layer is large. It is therefore considered that a joining strength between the first metal layer and the second metal layer is large.

Japanese Laid-open Pat. Publication No. 2011-124024 discloses an assembled battery including a plurality of battery cells connected to each other via a bus bar. The battery cell includes a positive electrode terminal and a negative electrode terminal. Of the positive electrode terminal and the negative electrode terminal, one having one polarity with a lower welding quality with the bus bar includes an external terminal formed of a material with a better welding quality with the bus bar and a base. It is thus considered that it is possible to reduce a yield due to a defect of a short circuit between a positive electrode and a negative electrode.

### SUMMARY

The inventors have examined increasing a joinability between an external connection component, such as a bus bar or the like, and an electrode terminal by using a terminal component formed of a plurality of types of metals. An outer shape of the terminal component formed of the plurality of types of metals can be molded, for example, by pressure-molding a metal material. In trials conducted by the present inventors, in a case where an outer shape of a terminal component formed of a plurality of types of metals was molded by pressurizing, a phenomenon that burrs are generated in a portion of the terminal component was observed. The present inventors desire to provide a technology that suppresses generation of burrs in a terminal component for a secondary battery.

A terminal component disclosed herein is a terminal component for a secondary battery which has a plate-like head portion with a bottom surface and an upper surface in an opposite side to the bottom surface and a shaft portion extending from the bottom surface. The terminal component includes a first metal, and a second metal joined to the first metal and having a higher ductility than that of the first metal. The bottom surface of the head portion is formed of the first metal. The upper surface of the head portion is formed of the second metal. A circumferentially continuous chamfered portion is provided in an outer end portion of the bottom surface of the head portion. A boundary between the first metal and the second metal is formed in the chamfered portion. In the terminal component having a configuration described above, generation of burrs is suppressed.

The terminal component may be formed of a cladding material in which the first metal and the second metal are joined to each other. In at least one of the first metal and the second metal, the chamfered portion may be harder than a portion located in a more inner side than the chamfered portion. The head portion may have a rectangular shape when viewed from top. An average of difference between a maximum value and a minimum value of a distance from each side of the bottom surface of the head portion to the boundary may be within 200 µm.

As another aspect of a technology disclosed herein, a secondary battery is provided. The second battery includes a battery case and a positive electrode terminal and a negative electrode terminal mounted on the battery case. At least one of the positive electrode terminal and the negative electrode terminal includes the terminal component described above.

As still another aspect of the technology disclosed herein, a method for producing a terminal component is provided. The method for producing a terminal component is a method for producing a terminal component for a secondary battery which has a plate-like head portion with a bottom surface and an upper surface in an opposite side to the bottom surface and a shaft portion extending from the bottom surface. The method for producing a terminal component includes preparing a metal material including a first metal and a second metal having a higher ductility than that of the first metal, and plastically deforming the metal material into a shape corresponding to a shape of a mold, the mold including a first molding member that molds the head portion and a second molding member that molds the shaft portion, being configured such that the first molding portion has an abutting surface that molds a circumferentially continuous chamfered portion and on which a corner portion of the first metal is linearly abutted in an outer end portion of the bottom surface. In the plastically deforming, the first metal of the metal material is placed on the abutting surface and a pressure is applied from a side of the second metal. According to the method for producing a terminal component, generation of burrs is suppressed.

In the preparing, as the metal material, a cladding material in which the first metal and the second metal are joined to each other may be prepared.

### BRIEF DESCRIPTION OF THE DRAWINGS

FIG. 1 is a partial cross-sectional view of a lithium-ion secondary battery 10.

FIG. 2 is a cross-sectional view taken along a line II-II of FIG. 1.

FIG. 3A is a schematic view illustrating a method for producing a terminal component 61.

FIG. 3B is a schematic view illustrating the method for producing the terminal component 61.

FIG. 3C is a schematic view illustrating the method for producing the terminal component 61.

FIG. 4A is a cross-sectional view schematically illustrating a mold 190 having an abutting surface 191a with a circular arc shape.

FIG. 4B is a cross-sectional view schematically illustrating a mold 290 having an abutting surface 291a with a stepped shape.

### DETAILED DESCRIPTION

One embodiment of a terminal component, a secondary battery, and a method for producing a terminal device disclosed herein will be described below. As a matter of course, the embodiment described herein is not intended to be particularly limiting the present disclosure. The accompanying drawings are schematic and do not necessarily reflect actual members or portions. The notation “A to B” or the like that indicates a numerical range means “A or more and B or less” unless specifically stated otherwise. Note that, in the following drawings, members/portions that have the same effect may be denoted by the same sign and the overlapping description may be omitted or simplified. In addition, in the accompanying drawings referenced herein, the sign X indicates a “long side direction,” the sign Y indicates a “short side direction,” and the sign Z indicates a “height direction.”

As used herein, a term “secondary battery” refers to overall storage devices in which charge carriers move between a pair of electrodes (a positive electrode and a negative electrode) via an electrolyte and thus a charging and discharging reaction occurs. Such secondary batteries include not only so-called storage batteries, such as a lithium-ion secondary battery, a nickel hydrogen battery, a nickel cadmium battery, or the like, but also capacitors, such as an electric double-layered capacitor or the like. An embodiment in which a lithium-ion secondary battery, among the above-described secondary batteries, is a target will be described below.

### Lithium-ion Secondary Battery 10

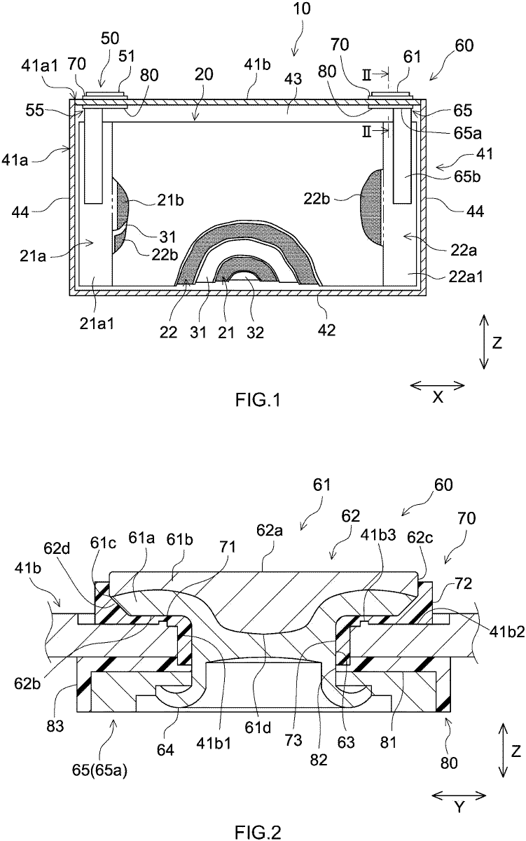

FIG. 1 is a partial cross-sectional view of a lithium-ion secondary battery 10 (which will be hereinafter referred to simply as a secondary battery 10 as well) including a terminal component disclosed herein as an external terminal 61 of a negative electrode. In FIG. 1, a state where an inside of the lithium-ion secondary battery 10 is exposed along a broad width surface on one side of a battery case 41 having an approximately rectangular parallelepiped shape is illustrated. As illustrated in FIG. 1, the lithium-ion secondary battery 10 includes an electrode body 20, a battery case 41 having a case body 41a with an opening 41a1 and a lid 41b that closes the opening 41a1 of the case body 41a, and a positive electrode terminal 50 and a negative electrode terminal 60 mounted on the battery case 41.

### Electrode Body 20

The electrode body 20 is housed in the battery case 41 in a state where the electrode body 20 is covered by an insulation film (not illustrated) or the like. The electrode body 20 includes a positive electrode sheet 21 as a positive element, a negative electrode sheet 22 as a negative electrode element, and separator sheets 31 and 32 as separators. Each of the positive electrode sheet 21, the first separator sheet 31, the negative electrode sheet 22, and the second separator sheet 32 is a long band-like member.

The positive electrode sheet 21 is configured such that a positive electrode active material layer 21b containing a positive electrode active material is formed on each of both surfaces on a positive electrode current collecting foil 21a (for example, an aluminum foil) having preset width and thickness excluding an unformed portion 21a1 set to have a uniform width in an end portion on one side in a width direction. For example, in a lithium-ion secondary battery, the positive electrode active material is a material, such as a lithium transition metal compound material, that emits lithium ions during charging and absorbs lithium ions during discharging. In general, various other materials than the lithium transition metal compound material have been proposed for positive electrode active materials, and there is no particular limitation on the positive electrode active material used herein.

The negative electrode sheet 22 is configured such that a negative electrode active material layer 22b containing a negative electrode active material is formed on each of both surfaces on a negative electrode current collecting foil 22a (a copper foil herein) having preset width and thickness excluding an unformed portion 22a1 set to have a uniform width in an edge on one side in the width direction. For example, in a lithium-ion secondary battery, the negative electrode active material is a material, such as natural graphite, that absorbs lithium ions during charging and emits lithium ions that have been absorbed during charging during discharging. In general, various other materials than the natural graphite have been proposed for negative electrode active materials, and there is no particular limitation on the negative electrode active material used herein.

For each of the separator sheets 31 and 32, for example, a porous resin sheet which has a required heat resistance and through which an electrolyte can pass is used. Various proposals have been made for the separator sheets 31 and 32, and there is no particular limitation on the separator sheets 31 and 32.

Herein, the negative electrode active material layer 22b is formed, for example, to have a width larger than that of the positive electrode active material layer 21b. Each of the separator sheets 31 and 32 has a width larger than that of the negative electrode active material layer 22b. The unformed portion 21a1 of the positive electrode current collecting foil 21a and the unformed portion 22a1 of the negative electrode current collecting foil 22a are disposed to face opposite directions away from each other in the width direction. The positive electrode sheet 21, the first separator sheet 31, the negative electrode sheet 22, and the second separator sheet 32 are stacked in this order and are wound such that directions thereof are aligned in a long-side direction. The negative electrode active material layer 22b covers the positive electrode active material layer 21b with the separator sheets 31 and 32 interposed between the negative electrode active material layer 22b and the positive electrode active material layer 21b. The negative electrode active material layer 22b is covered by the separator sheets 31 and 32. The unformed portion 21a1 of the positive electrode current collecting foil 21a protrudes from one side of the separator sheets 31 and 32 in the width direction. The unformed portion 21a1 of the negative electrode current collecting foil 22a protrudes from the separator sheets 31 and 32 in an opposite side in the width direction.

As illustrate in FIG. 1, the electrode body 20 described above is formed to be flat along a single plane including a winding axis to be housed in a case body 41a of the battery case 41. Along the winding axis of the electrode body 20, the unformed portion 21a1 of the positive electrode current collecting foil 21a is disposed on one side and the unformed portion 22a1 of the negative electrode current collecting foil 22a is disposed in an opposite side.

### Battery Case 41

The battery case 41 houses the electrode body 20 therein. The battery case 41 includes the case body 41a having an approximately rectangular parallelepiped shape with an opening on one side surface and the lid 41b attached to the opening. In this embodiment, from a view point of reducing a weight and ensuring a required rigidity, each of the case body 41a and the lid 41b is formed of aluminum or an aluminum alloy mainly containing aluminum. Although, in the embodiment illustrated in FIG. 1, a wound type electrode body 20 is illustrated as an example, a structure of the electrode body 20 is not limited thereto. The structure of the electrode body 20 may be, for example, a stacked structure in which a positive electrode sheet and a negative electrode sheet are alternately stacked via a separator sheet therebetween. A plurality of electrode bodies 20 may be housed in the battery case 41.

The battery case 41 may be configured to house an unillustrated electrolytic solution with the electrode body 20. As the electrolytic solution, a nonaqueous electrolytic solution obtained by dissolving a supporting salt into a non-aqueous solvent may be used. Examples of the non-aqueous solvent include a carbonate base solvent, such as ethylene carbonate, dimethyl carbonate, ethyl methyl carbonate, or the like. Examples of the supporting salt include a fluorine-containing lithium salt, such as LiPF₆ or the like.

### Case Body 41a

The case body 41a has an approximately rectangular parallelepiped shape with an opening on one side surface. The case body 41a has an approximately rectangular bottom surface portion 42, a pair of broad width surface portions 43, and a pair of narrow width surface portions 44. Each of the pair of broad width surface portions 43 rises from a corresponding long side of the bottom surface portion 42. Each of the pair of narrow width surface portions 44 rises from a corresponding short side of the bottom surface portion 42. The opening 41a1 surrounded by the pair of broad width surface portions 43 and the pair of narrow width surface portions 44 is formed in one side surface of the case body 41a.

### Lid 41b

The lid 41b seals the opening 41a1 of the case body 41a. In this embodiment, the lid 41b has a rectangular shape when viewed from top. The lid 41b is attached to the opening 41a1 of the case body 41a. A peripheral portion of the lid 41b is joined to an edge of the opening 41a1 of the case body 41a. The above-described joining may be achieved, for example, by continuous welding without any gap. Such welding can be realized, for example, by laser welding.

The positive electrode terminal 50 and the negative electrode terminal 60 are mounted on the lid 41b. Each of the positive electrode terminal 50 and the negative electrode terminal 60 includes a corresponding one of external terminals 51 and 61 and a corresponding one of internal terminals 55 and 65. Each of the external terminals 51 and 61 is mounted on an outside of the lid 41b via a gasket 70. Each of the internal terminals 55 and 65 is mounted on an inside of the lid 41b via an insulator 80. Each of the internal terminals 55 and 65 extends inside the case body 41a. The unformed portion 21a1 of the positive electrode current collecting foil 21a and the unformed portion 22a1 of the negative electrode current collecting foil 22a in the electrode body 20 are mounted on the internal terminals 55 and 65 each being mounted on a corresponding one of both side portions of the lid 41b in a longitudinal direction, respectively.

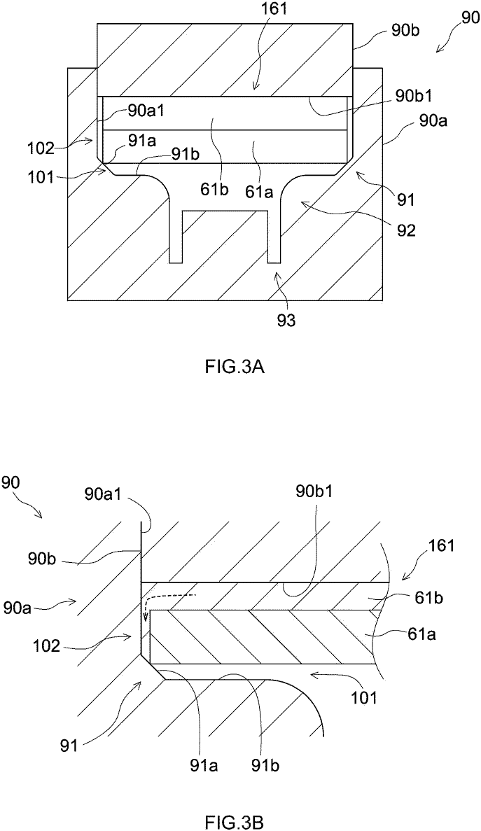

FIG. 2 is a cross-sectional view taken along a line II-II of FIG. 1. In FIG. 2, a cross section of a portion in which the negative electrode terminal 60 is mounted on the lid 41b. A portion in which the positive electrode terminal 50 is mounted on the lid 41b can have a similar configuration, and therefore, description thereof will be omitted. As illustrated in FIG. 2, the lid 41b includes a mounting hole 41b1 in which the external terminal 61 is mounted. The mounting hole 41b1 passes through the lid 41b in a preset position in the lid 41b. The internal terminal 65 and the external terminal 61 are mounted in the mounting hole 41b1 of the lid 41b with the gasket 70 and the insulator 80 interposed therebetween. In outside of the mounting hole 41b1, a seating surface 41b2 on which the gasket 70 is attached is provided around the mounting hole 41b1. A protrusion 41b3 used for positioning the gasket 70 is provided on the seating surface 41b2.

### External Terminal 61

The external terminal 61 includes a head portion 62, a shaft portion 63, and a caulking piece 64. The head portion 62 is a plate-like potion that spreads from one end portion of the shaft portion 63 in a radial direction. The head portion 62 is a portion connected to a bus bar. The bus bar can be connected, for example, to an upper surface 62a of the head portion 62 by welding. The shaft portion 63 is a portion attached to the mounting hole 41b1 via the gasket 70. The caulking piece 64 is a portion caulked to the internal terminal 65 inside the lid battery case 41. The caulking piece 64 extends from the shaft portion 63, is bent after being inserted in the lid 41b, and is caulked to the internal terminal 65 of the negative electrode.

### Gasket 70

The gasket 70 is a member mounted on the mounting hole 41b1 and the seating surface 41b2 of the lid 41b. The gasket 70 is disposed between the lid 41b and the external terminal 61 to ensure insulation between the lid 41b and the external terminal 61. The gasket 70 is compressed and mounted in the mounting hole 41b1 of the lid 41b to ensure airtightness of the battery case 41. The gasket 70 includes a seating portion 71 disposed between the head portion 62 and the lid 41b, a side wall 72 that rises upward from the seating portion 71, and a boss portion 73 that protrudes from a bottom surface of the eating portion 71.

The seating portion 71 is a portion attached to the seating surface 41b2 provided on an outer surface of the lid 41b around the mounting hole 41b1. The seating portion 71 has an outer dimension one round larger than that of the head portion 62 when viewed from top. The seating portion 71 has an approximately flat surface in accordance with the seating surface 41b2. The seating portion 71 includes a recess corresponding to the protrusion 41b3 of the seating surface 41b2. The boss portion 73 protrudes from a bottom surface of the seating portion 71. The boss portion 73 has an outer shape along an inner surface of the mounting hole 41b1 to be mounted in the mounting hole 41b1. An inner surface of the boss portion 73 is an attaching hole to which the shaft portion 63 of the external terminal 61 is attached. The side wall 72 rises upward from a peripheral edge of the seating portion 71 and extends upward. The head portion 62 of the external terminal 61 is surrounded by the side wall 72 of the gasket 70. For the gasket 70, a material excellent in chemical resistance and weather resistance may be used. Although not particularly limited, for example, a tetrafluoroethylene-perfluoroalkylvinylether copolymer (PFA) can be used for the gasket 70.

### Insulator 80

The insulator 80 is a member attached to the inside of the lid 41b around the mounting hole 41b1 of the lid 41b. The insulator 80 includes a base portion 81, a hole 82, and a side wall 83. The base portion 81 is a portion disposed along an inner surface of the lid 41b. In this embodiment, the base portion 81 is an approximately flat plate-like portion. The base portion 81 is disposed along the inner surface of the lid 41b and has a size with which the base portion 81 does not protrude from the lid 41b so as to be accommodated in the case body 41a. The hole 82 is provided to correspond to the inner surface of the boss portion 73 of the gasket 70. In this embodiment, the hole 82 is provided in an approximately central portion of the base portion 81. A recessed step is provided around the hole 82 on a side surface opposed to the inner surface of the lid 41b. A tip end of the boss portion 73 of the gasket 70 attached to the mounting hole 41b1 is accommodated in the step without interference. The side wall 83 rises from a peripheral portion of the base portion 81 and extends downward. A base 65a provided at one end of the internal terminal 65 is accommodated in the base portion 81. The insulator 80 is disposed inside the battery case 41, and therefore, may have a required chemical resistance. In this embodiment, polyphenylene sulfide resin (PPS) is used for the insulator 80. A material used for the insulator 80 is not limited to PPS.

### Internal Terminal 65

The internal terminal 65 includes the base 65a and a connection piece 65b (see FIG. 1). The base 65a is a portion attached to the base portion 81 of the insulator 80. In this embodiment, the base 65a has a shape corresponding to an inside of the side wall 83 around the base portion 81 of the insulator 80. The connection piece 65b extends from one end of the base 65a, further extends in the case body 41a, and is connected to the unformed portion 22a1 of the negative electrode of the electrode body 20 (see FIG. 1).

In this embodiment, the boss portion 73 is attached to the mounting hole 41b1 and the gasket 70 is mounted on the outside of the lid 41b. Subsequently, the external terminal 61 is attached to the gasket 70. At this time, the shaft portion 63 of the external terminal 61 is inserted through the boss portion 73 of the gasket 70 and the head portion 62 of the external terminal 61 is disposed on the seating portion 71 of the gasket 70. The insulator 80 and the internal terminal 65 are mounted on the inside of the lid 41b. The caulking piece 64 of the external terminal 61 is bent and is caulked to the base 65a of the internal terminal 65. The caulking piece 64 of the external terminal 61 and the base 65a of the internal terminal 65 may be partially welded to each other in order to improve conductivity.

Incidentally, in the internal terminal 55 of the positive electrode of the lithium-ion secondary battery 10, a required level of oxidation reduction resistance is not as high as that in the negative electrode. From a view point of the required oxidation reduction resistance and reduction in weight, aluminum, an aluminum alloy, or the like can be used for the internal terminal 55 of the positive electrode. In contrast, in the internal terminal 65 of the negative electrode, a required level of oxidation reduction resistance is higher than that in the positive electrode. In view of the foregoing, copper, a copper alloy, or the like can be used for the internal terminal 65 of the negative electrode. On the other hand, as the bus bar connected to the external terminals 51 and 61, from a view point of reduction in weight and cost cut, aluminum or an aluminum alloy can be used. The external terminals 51 and 61 connected to the internal terminals 55 and 65 are made of metals. Metals used as the external terminals 51 and 61 are selected as appropriate in accordance with types of the bus bar and the internal terminals 55 and 65 or the like.

In a case where the internal terminal 55 and the bus bar are formed of a same type of metal, from the viewpoint of increasing a joinability, the external terminal 51 of the positive electrode is preferably formed of a same type of metal as that of the internal terminal 55 and the bus bar. The external terminal 51 is preferably formed of aluminum or an aluminum alloy.

On the other hand, in the negative electrode terminal 60, the internal terminal 65 and the bus bar can be formed of different metals. The present inventors have examined that a same type of metal as that of the internal terminal 65 is used for a portion (in this embodiment, the caulking piece 64) of the external terminal 61 that is connected to the internal terminal 65, and a same type of metal as that of the bus bar is used for a portion (in this embodiment, the upper surface 62a of the head portion 62) of the external terminal 61 that is connected to the bus bar. Herein, using a terminal component 61 that can be used as the external terminal 61 and includes a portion formed of aluminum and a portion formed of copper as an example, a terminal component according to the present disclosure will be described. The metals forming the terminal component 61 is not limited to copper and aluminum. Types of metals forming the terminal component 61 can be set as appropriate in accordance with a type of the secondary battery 10, types of metals to which the internal terminal 65, the bus bar, or the like is joined, or the like. The terminal component 61 disclosed herein will be described below as well as a method for producing the terminal component 61.

### Terminal Component 61

The terminal component 61 can be used as the external terminal 61 for a secondary battery. In FIG. 2, a cross section of the terminal component 61 is schematically illustrated. The terminal component 61 includes the plate-like head portion 62 having a bottom surface 62b and an upper surface 62a in an opposite side to the bottom surface 62b and the shaft portion 63 extending from the bottom surface 62b. In this embodiment, the head portion 62 has a rectangular plate-like shape. The head portion 62 has a side circumferential surface 62c extending from the upper surface 62a to the bottom surface 62b. A circumferentially continuous chamfered portion 62d is provided in an outer end portion of the bottom surface 62b of the head portion 62. The chamfered portion 62d is formed to be circumferentially continuous so as to connect the side circumferential surface 62c and the bottom surface 62b to each other.

In this specification, a “chamfered portion” is a portion formed in an outer end portion of a bottom surface and having a shape with a corner portion chamfered. There is no particular limitation on the shape of the chamfered portion. For example, the shape of the chamfered portion may be a C-chamfered shape in which a corner portion is cut off at a predetermined angle, may be an R-chamfered shape in which a corner portion is rounded, may be a scooped surface shape in which a cross section of a corner portion has a rectangular recessed shape, and may be a shape achieved by combining the above-described shapes. In this embodiment, the chamfered portion 62d is a C-chamfered shape in which a surface extending from a lower end of the side circumferential surface 62c to an outer periphery of the bottom surface 62b is inclined by an angle of about 45 degrees.

The terminal component 61 includes a first metal 61a and a second metal 61b joined to the first metal 61a and having a higher ductility than that of the first metal 61a. In other words, the terminal component 61 includes a portion formed of the first metal 61a and a portion formed of the second metal 61b. In this embodiment, the first metal 61a is copper. The second metal 61b is aluminum.

The upper surface 62a of the head portion 62 is formed of the second metal 61b. The side circumferential surface 62c of the head portion is formed of the second metal 61b. The bottom surface 62b of the head portion 62 is formed of the first metal 61a. A boundary 61c between the first metal 61a and the second metal 61b is formed in the chamfered portion 62d. The boundary 61c is continuously formed along the chamfered portion 62d in a circumferential direction. The boundary 61c is not formed at least on the bottom surface 62b.

The boundary 61c is formed so as not to largely meander along the chamfered portion 62d. In this embodiment, as described above, the head portion 62 has a rectangular shape when viewed from top. In that case, although not particularly limited, an average of a difference between a maximum value and a minimum value of a distance from each side of the bottom surface 62b of the head portion 62 to the boundary 61c is within 200 µm.

A boundary surface 61d between the first metal 61a and the second metal 61b is formed inside the terminal component 61. In this embodiment, as illustrated in FIG. 2, the boundary surface 61d is formed into a curved shape. In this embodiment, the terminal component 61 is formed of a cladding material in which the first metal 61a and the second metal 61b are joined to each other.

### Method for Producing Terminal Component 61

A method for producing the terminal component 61 having the above-described configuration includes
(a) preparing a metal material 161 including the first metal 61a and the second metal 61b having a higher ductility than that of the first metal 61a, and
(b) plastically deforming the metal material 161 into a shape corresponding to a shape of a mold 90.

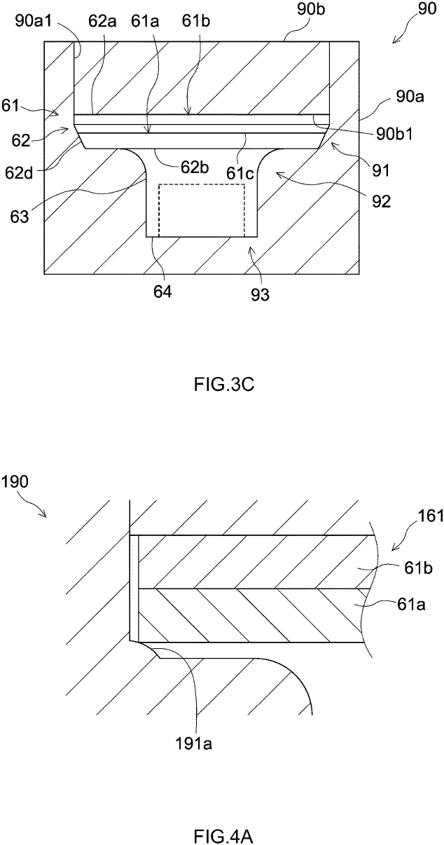

FIG. 3A, FIG. 3B, and FIG. 3C are schematic views illustrating a method for producing the terminal component 61. In FIG. 3A, a cross section of the mold 90 used for producing the terminal component 61 and a side surface of the metal material 161 placed in the mold 90 are illustrated. In FIG. 3B, a cross-sectional shape of the metal material 161 under pressure is schematically illustrated. In FIG. 3C, a cross section of the mold 90 and a side surface of the molded terminal component 61 are illustrated.

### Step (a): Preparing

In preparing, the metal material 161 that is a material of the terminal component 61 is prepared. In this embodiment, as the metal material 161, a cladding material 161 in which the first metal 61a and the second metal 61b are joined to each other is prepared. The cladding material 161 has a rectangular plate-like shape, one surface thereof is formed of the first metal 61a, and the other surface thereof is formed of the second metal 61b. In this embodiment, the cladding material 161 is a so-called overlay type cladding material. In the cladding material 161, a flat boundary surface is formed in a plane orthogonal to a thickness direction. Full surfaces of the first metal 61a and the second metal 61b are joined to each other through diffusion joining at the boundary surface.

The first metal 61a and the second metal 61b of the cladding material 161 are formed of metals similar to metals used for the terminal component 61. There is no particular limitation on a configuration of the cladding material 161, and the configuration can be set as appropriate in accordance with a shape of the terminal component 61 or the like. Respective thicknesses or the like of the portion formed of the first metal 61a and the portion formed of the second metal 61b may be about same or may be different. The cladding material 161 is not limited to the overlay type cladding material described above and, for example, a so-called inlay type cladding layer, a so-called edge lay type cladding material, or the like may be used for the cladding material 161.

Although not particularly limited, the cladding material 161 can be produced, for example, in a manner as follows. First, a metal plate made of the first metal 61a and a metal plate made of the second metal 61b are prepared. Subsequently, the prepared metal plates are stacked, and are rolled and joined using a rolling press machine. The metal plates that have been rolled and joined may be punched or the like to arrange a shape, thereby producing the cladding material 161. In order to increase a joining strength between dissimilar metals, the rolled and joined metal plates may be heat treated.

### Step (b): Plastically Deforming

In plastically deforming, the mold 90 corresponding to the shape of the terminal component 61 is used. As illustrated in FIG. 3A, the mold 90 used for producing the terminal component 61 includes a lower mold 90a and an upper mold 90b. The mold 90 includes a first molding member 91 that molds the head portion 62 and a second molding member 92 that molds the shaft portion 63. The mold 90 includes a third molding member 93 that molds the caulking piece 64. The first molding member 91 to the third molding member 93 are provided in the lower mold 90a. The lower mold 90a has a side wall 90a1 corresponding to a shape of the side circumferential surface 62c above the first molding member 91. An opening used for introducing the metal material 161 is formed in an upper end of the side wall 90a1.

In the first molding member 91, an abutting surface 91a that molds the circumferentially continuous chamfered portion 62d in the outer end portion of the bottom surface 62b of the head portion 62 and on which a corner portion of the first metal 61a is linearly abutted is provided. The abutting surface 91a is continuously provided in the circumferential direction so as to connect a portion 91b that molds the bottom surface 62b and a portion (the side wall 90a1) that molds the side circumferential surface 62c. In this embodiment, the abutting surface 91a is an inclined surface that is inclined by about 45 degrees with respect to the portion 91b that molds the bottom surface 62b and the side wall 90a1.

The upper mold 90b is inserted in the lower mold 90a from the opening. Therefore, dimensions of a side surface of the upper mold 90b are smaller than those of the opening and the side wall 90a1. From a view point of preventing the metal material 161 that is plastically deformed when pressing is performed from flowing in between the lower mold 90a and the upper mold 90b, a difference between the dimensions of an inner side surface of the upper mold 90b and the dimensions of the side wall 90a1 is preferably as small as possible. In the upper mold 90b, a pressurizing surface 90b1 corresponding to the upper surface 62a of the head portion 62 of the terminal component 61 is formed. In this embodiment, the pressurizing surface 90b1 is a flat surface corresponding to the upper surface 62a. A shape of the pressurizing surface 90b1 is not limited thereto. In the upper surface 62a of the head portion 62 of the terminal component 61, for example, a structure of a protrusion, a recess, or the like used for mounting and positioning the bas bar can be provided. In that case, the shape of the pressurizing surface 90b1 may be set in accordance with a shape of the upper surface 62a.

In plastically deforming, the first metal 61a of the metal material 161 (in this embodiment, the cladding material 161) is placed on the abutting surface 91a and a pressure is applied from a side of the second metal 61b. In this embodiment, the cladding material 161 is pressurized by so-called cold-forging in which compression molding is performed at normal temperature using the mold 90.

First, the cladding material 161 is introduced to the lower mold 90a from the opening and is placed on the abutting surface 91a. At that time, the cladding material 161 is introduced such that the first metal 61a is located at bottom. The corner portion of the first metal 61a is circumferentially continuous and is linearly abutted on the abutting surface 91a. The cladding material 161 is supported by the abutting surface 91a on which the corner portion of the first metal 61a is linearly abutted. With the cladding material 161 supported by the abutting surface 91a, a gap 101 is formed between a surface of the first metal 61a and the portion 91b of the lower mold 90a that molds the bottom surface 62b of the head portion 62. A gap 102 is formed between a side circumferential surface of the cladding material 161 and the side wall 90a1.

Next, the cladding material 161 is pressurized in the mold 90. An unillustrated press machine is attached to the upper mold 90b. The press machine is configured such that press conditions, such as a press load, press speed, a press time, or the like, can be set. The upper mold 90b is lowered relative to the lower mold 90a to pressurize the cladding material 161. Although not particularly limited, the press load can be set to about 20 kN to 100 kN. In continuously producing a plurality of terminal components 61, the press speed can be set to about 30 shot/min to 80 shot/min. When the cladding material 161 is pressurized in the mold 90, the cladding material 161 is plastically deformed into a shape corresponding to an internal shape of the mold 90. Then, the boundary surface 61d (see FIG. 2) between the first metal 61a and the second metal 61b is formed in a curved shape.

Incidentally, in a case where the metal material is pressurized to be plastically deformed, before pressurizing, a gap exists between the metal material that is to be molded and the mold. For example, in order to place the metal material in the mold, it is necessary to set dimensions of a side surface of the metal material smaller than dimensions of an opening of the mold, and therefore, a gap is formed between the side surface of the metal material and the mold. Even on a surface on which the metal material contacts the mold (for example, a surface on which the metal material is placed in the mold), a minute gap is formed, and it is difficult to completely eliminate the gap. In trials conducted by the present inventors, in a case where a metal material including a plurality of types of metal was pressurized to be plastically deformed, a relatively soft metal (for example, a metal having a high ductility) was plastically deformed quickly and entered in a gap between a relatively hard metal and a mold in some cases. As in these cases, there is a concern that the metal that has entered in a gap becomes burrs, and in a case where the burrs peel off and pieces that have peeled off remain in the mold, bruises are formed on a terminal component that is to be produced later by the pieces. In a case where the burrs remain in the terminal component, there is another concern that a trouble occurs in producing a secondary battery using the terminal component. Furthermore, in a case where the burrs remain in the terminal component, there is still another concern that a trouble occurs also when the secondary battery using the terminal component becomes a product.

In this embodiment, the cladding material 161 is placed in a state where the corner portion of the first metal 61a is linearly abutted on the abutting surface 91a in a continuous manner in the circumferential direction, the upper mold 90b is set from a side in which the second metal having a high ductility is provided, and a pressure is applied. As illustrated in FIG. 3B, plastic deformation of the second metal having a high ductility quickly occurs and the second metal 61b flows in in a direction of an arrow in FIG. 3A. The gap 102 (see FIG. 3A) between the cladding material 161 and the side wall 90a1 is filled with the second metal. Subsequently, as illustrated in FIG. 3C, the first metal 61a sequentially flows in the first molding member 91, the second molding member 92, and the third molding member 93, and thus, the head portion 62, and the shaft portion 63, and the caulking piece 64 are formed. As a result, the terminal component 61 in which the boundary 61c is formed in a portion of the chamfered portion 62d on which the corner portion of the first metal 61a is abutted is produced.

In a portion that is pressed against the abutting surface 91a, a degree of plastic deformation tends to be large and work hardening tends to occur in the portion. Therefore, in at least one of the first metal 61a and the second metal 61b, the chamfered portion 62d can be harder than a portion located in a more inner side than the chamfered portion 62d. Because a degree of change in hardness differs depending on a metal type, the shape of the terminal component 61, or the like, there is no particular limitation on the degree of change in hardness. However, in the chamfered portion 62d, the degree of change in hardness can be, for example, 8% or more higher and furthermore can be 10% or more higher than that in the portion located in a more inner side than the chamfered portion 62d. There is no particular limitation on a method for evaluating hardness. Various methods can be employed in accordance with the metal type, the shape and dimensions of the terminal component 61, or the like. Hardness can be evaluated, for example, by a Vickers hardness test, a Brinell hardness test, a Knoop hardness test, a Rockwell hardness test, or the like.

In a manner described above, the terminal component 61 can be achieved. As described above, in the first molding member 91, the abutting surface 91a on which the corner portion of the first metal 61a is linearly abutted is provided, so that, even with continued pressurizing, the second metal can be prevented from entering under the mold 90. Thus, the second metal does not enter the gap 101 (see FIG. 3A) and the gap 101 is filled with the plastically deformed first metal. As a result, as illustrated in FIG. 3C, in the terminal component 61, the chamfered portion 62d formed by the abutting surface 91a is formed. In the chamfered portion 62d, the boundary 61c between the first metal 61a and the second metal 61b is formed. By a production method described above, the terminal component 61 in which the second metal is prevented from entering the bottom surface 62b of the head portion 62 and generation of burrs of the second metal 61b is suppressed is produced.

The terminal component 61 disclosed herein has a high degree of freedom in shape processing. For example, in a case where a terminal component is produced using a mold in which the abutting surface 91a is not provided, in order to prevent generation of burrs, it has been necessary to enhance adhesion between the metal material and the mold in which the metal material is placed. Therefore, each of the metal material and a portion in which the metal material is placed can have a flat surface. In the terminal component 61 disclosed herein, the abutting surface 91a is provided, and thus, a shape of the mold 90 can be set in accordance with a desired shape in a portion lower than the abutting surface 91a. For example, a protrusion, a step, or the like used for positioning the terminal component relative to the gasket can be provided. Such a structure can be provided in the terminal component without additional processing, such as cutting or the like.

In the above-described embodiment, as the metal material 161, the cladding material 161 in which the first metal 61a and the second metal 61b are joined to each other is used. That is, at the boundary surface 61d between the first metal 61a and the second metal 61b, the full surfaces of the first metal 61a and the second metal 61b are joined to each other through diffusion joining. Therefore, at the boundary surface 61d, the first metal 61a and the second metal 61b are tightly joined to each other. Moreover, the first metal 61a and the second metal 61b are joined to each other through diffusion joining in a wide range, and thus, a conduction resistance between the first metal 61a and the second metal 61b is kept low.

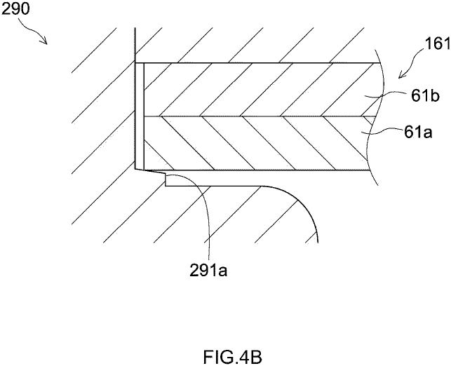

The terminal component produced in the above-described manner can be used for various types of second battery. A terminal component disclosed herein is not limited to the configuration described above and various changes can be made to the terminal component. For example, in the above-described embodiment, a shape of the chamfered portion 62d is a C-chamfered shape, but is not limited thereto. FIG. 4A is a cross-sectional view schematically illustrating a mold 190 having an abutting surface 191a with a circular arc shape. As illustrated in FIG. 4A, a chamfered portion may be formed into an arc-shaped recess using the mold 190 having the abutting surface 191a formed to have an arc-shaped cross section. As another option, the chamfered portion may be formed into an R-chamfered shape. FIG. 4B is a cross-sectional view schematically illustrating a mold 290 having an abutting surface 291a with a stepped shape. As illustrated in FIG. 4B, the chamfered portion may be formed into a stepped shape using the mold 290 having the abutting surface 291a formed to have a stepped cross-section. In the above-described embodiment, as the metal material, the cladding material is used, but the metal material is not limited thereto. For example, a metal material obtained by metallurgically joining or mechanically fastening a plurality of metal materials to each other may be used. A plurality of metals that are not joined to each other may be used. In a case where the metals that are not joined to each other are used, the metals may be joined by a method of welding or the like, after molding.

An example of a terminal component disclosed herein will be described below, but it is not intended to limit the present disclosure to the example.

### Example

Using the cladding material formed of the first metal (in this embodiment, copper) and the second metal (in this embodiment, aluminum) as a material, a terminal component according to an example was produced using a mold having a similar configuration to that of the mold 90 described above. In the mold, an abutting surface was provided. Dimensions of the abutting surface in a short side direction and a long side direction were set different. The abutting surface was set such that a shape of a chamfered portion in the long side direction was a C-chamfered shape of C0.25 and a shape of the chamfered portion in the short side direction was a C-chamfered shape of C0.5. The terminal component according to the example had a similar configuration to that of the terminal component 61. Specifically, the terminal component according to the example was formed to include a shaft portion, a head portion, and a caulking piece. The head portion was formed to have a rectangular plate-like shape. The circumferentially continuous chamfered portion was provided in an outer end portion of a bottom surface of the head portion.

### Comparative Example

A terminal component according to a comparative example was produced using a mold having a similar configuration to that of the mold described above except that no abutting surface was provided. The terminal component according to the comparative example is different from the terminal component of the example in that no chamfered surface was formed.

### Evaluation of Distance From Bottom Surface to Boundary

In the terminal component according to the comparative example, an upper surface and a side circumferential surface of the head portion were covered by the second metal. Burrs of the second metal were formed in a portion of the bottom surface of the heard portion of the terminal component according to the comparative example. In the terminal component according to the example, also, an upper surface and a side circumferential surface of the head portion were covered by the second metal. However, in the terminal component according to the example, burrs of the second metal were not formed in the bottom surface of the head portion. A boundary between the first metal and the second metal was formed in the chamfered portion of the terminal component according to the example. The boundary was not perfectly straight but was formed to slightly meander. For the terminal component according to the example in which burrs were not formed, a distance from the bottom surface to the boundary was evaluated. In this case, a distance from each side of the rectangular bottom surface to the boundary was measured using a dimension measuring instrument. First, the terminal component was placed such that one surface of the chamfered portion was in parallel with a measurement surface of the dimension measuring instrument. Subsequently, using the boundary between the chamfered portion and the bottom surface as a reference line, a maximum value and a minimum value of a distance to the boundary between the first metal and the second metal were measured. Also, for the other three surfaces of the chamfered portion, the maximum value and the minimum value were measured in a similar manner. Averages of the maximum value and the minimum value were calculated for the distances from the long sides and the distances from the short sides. Results are illustrated in Table 1.

TABLE 1

| | | |
|---|---|---|
| | From Long Side | From Short Side |
| Average of Maximum Value | 0.301 mm | 0.455 mm |
| Average of Minimum Value | 0.198 mm | 0.271 mm |

### Hardness Test

For the terminal component according to the example, a hardness of the chamfered portion and a hardness of a portion located in a more inner side than the chamfered portion (which will be hereinafter referred to as a “inner portion” as well) were compared by a Vickers hardness test. In both the first metal and the second metal, the hardnesses of the portions described above were tested. First, a cross section in a perpendicular direction to the bottom surface was exposed. A Vickers hardness in a position at a depth of 0.2 mm from a surface of the chamfered portion in a portion formed of the first metal was measured. The Vickers hardness was measured in three positions under similar conditions, and an average was calculated and was determined as the hardness of the chamfered portion of the first metal. Next, the Vickers hardness was measured in a position at a depth of 2 mm from a side circumferential surface in the portion formed of the first metal. The Vickers hardness was measured in three positions under similar conditions, and an average was calculated and was determined as the hardness of the inner portion of the first metal. Under similar conditions, a hardness test was performed on the second metal to measure respective hardnesses of the chamfered portion and the inner portion of the second metal. Results are illustrated in Table 2.

TABLE 2

| | | |
|---|---|---|
| | Chamfered Portion | Inner Portion |
| First Metal | 131 Hv | 121 Hv |
| Second Metal | 50 Hv | 45 Hv |

The shape of the head portion when viewed from top was a rectangular shape. As can be seen from Table 1, an average of a difference between the maximum value and the minimum value of the distance from each side of the bottom surface of the head portion to the boundary was within 200 µm for both the distances from the long sides and the distances from the short sides. As can be seen from Table 2, in the first metal (in this embodiment, copper), the hardness of the chamfered portion was 8.2% higher than the hardness of the inner portion. In the second metal (in this embodiment, aluminum), the hardness of the chamfered portion was 11.1% higher than the hardness of the inner portion.

A secondary battery disclosed herein has been described above in various manners. The embodiment of a terminal component, a secondary battery, and a method for producing a terminal component disclosed herein shall not limit the present disclosure, unless specifically stated otherwise. Various changes can be made to the terminal component, the secondary battery, and the method for producing a terminal component disclosed herein, and each of components and processes described herein can be omitted as appropriate or can be combined with another one or other ones of the components and the processes as appropriate, unless a particular problem occurs.

What is claimed is:

1. A terminal component for a secondary battery which has a plate-like head portion with a bottom surface and an upper surface in an opposite side to the bottom surface and a shaft portion extending from the bottom surface, the terminal component comprising:
a first metal; and
a second metal joined to the first metal and having a higher ductility than that of the first metal,
wherein
the bottom surface of the head portion is formed of the first metal,
the upper surface of the head portion is formed of the second metal,
a circumferentially continuous chamfered portion is provided in an outer end portion of the bottom surface of the head portion, and
a boundary between the first metal and the second metal is formed in the chamfered portion.

2. The terminal component according to claim 1,
wherein
the terminal component is formed of a cladding material in which the first metal and the second metal are joined to each other.

3. The terminal component according to claim 1,
wherein
in at least one of the first metal and the second metal, the chamfered portion is harder than a portion located in a more inner side than the chamfered portion.

4. The terminal component according to claim 1,
wherein
the head portion has a rectangular shape when viewed from top, and
an average of a difference between a maximum value and a minimum value of a distance from each side of the bottom surface of the head portion to the boundary is within 200 µm.

5. A secondary battery comprising:
a battery case;
a positive electrode terminal and a negative electrode terminal mounted on the battery case,
wherein
at least one of the positive electrode terminal and the negative electrode terminal includes the terminal component according to claim 1.

6. A method for producing a terminal component for a secondary battery which has a plate-like head portion with a bottom surface and an upper surface in an opposite side to the bottom surface and a shaft portion extending from the bottom surface, the method comprising:
preparing a metal material including a first metal and a second metal having a higher ductility than that of the first metal; and
plastically deforming the metal material into a shape corresponding to a shape of a mold, the mold including a first molding member that molds the head portion and a second molding member that molds the shaft portion, being configured such that the first molding portion has an abutting surface that molds a circumferentially continuous chamfered portion and on which a corner portion of the first metal is linearly abutted in an outer end portion of the bottom surface,
wherein
in the plastically deforming, the first metal of the metal material is placed on the abutting surface and a pressure is applied from a side of the second metal.

7. The method for producing a terminal component according to claim 6, wherein
in the preparing, as the metal material, a cladding material in which the first metal and the second metal are joined to each other is prepared.
